(19) United States
(12) Patent Application Publication
(10) Pub. No.: US 2011/0095463 A1
(43) Pub. Date: Apr. 28, 2011

(54) Multiple size-fitting clamp pad pods and clamp assembly

(76) Inventor: Harry W. Eberle, III, Califon, NJ (US)

(21) Appl. No.: 12/589,658

(22) Filed: Oct. 27, 2009

(51) Int. Cl. B25B 5/16; B25B 5/02; B25B 5/10

(52) U.S. Cl. 269/6; 269/271; 269/147

(57) ABSTRACT

A multiple size fitting clamp pad pod that functions both as a clamp pad and as a support pod, includes: a main vertical wall with a front, a back, a top, sides and a bottom, and a frontal view footprint that includes a central orifice adapted to fit onto and receive a first clamp bar and that includes at least two opposing rest points located on the bottom. The central orifice has a first predetermined shape and open area to fit freely onto and receive the first clamp bar, and a break-away impression surrounding the central orifice to establish a second predetermined shape and open area to fit freely onto and receive a second clamp bar larger than the first clamp bar when the break-away impression is breached; and, a plurality of sidewalls located on and directed away from the main wall front.

### BACKGROUND OF INVENTION

a. Field of Invention

The invention relates generally to clamps, and more specifically to modifications to portable clamps. While permanently attached clamps (e.g., vices) are designed for functional clearances and usually have large surface area jaws, many portable clamps, such as the older pipe clamps and the newer bar clamps, have small jaws and lack functional clearance when on a table or on or near other surfaces. The present invention is thus directed to a combination device that functions both as an expanded area clamp pad and as a table pod for creating support and clearance, while being produced by simple (non-compound) injection molding.

b. Description of Related Art

The following patents are representative of the field pertaining to the present invention:

U.S. Pat. No. 6,889,966 B2 to John Wirth, Jr. et al. describes a clamp pad for being selectively mounted to each jaw of a bar clamp assembly. The clamp pad can be easily mounted to the clamp jaw and radially locked in place with respect to the bar clamp assembly. In an embodiment of the invention, the clamp pad is configured to selectively be fit on either of the clamp jaws of the bar clamp assembly to facilitate assembly. The clamp pad defines a substantially increased clamping area to evenly distribute force and prevent damage to the associated work piece. The increased dimensions of the clamp pad also stabilizes the bar clamp assembly, which eliminates tipping and thus eliminates the need for associated assemblies such as clamp saddles and the like.

U.S. Pat. No. 6,302,386 B1 to Anthony B. Fuller et al. describes a full face clamp pad having an engagement surface and a receiving element attached to the engagement surface, wherein the receiving element defines a closed opening that faces the engagement surface. The engagement surface and the receiving element define a second opening that faces in a direction substantially parallel to the engagement surface.

U.S. Pat. No. 5,988,616 to Anthony B. Fuller et al. describes a full face clamp pad having an engagement surface and a receiving element attached to the engagement surface, wherein the receiving element defines a closed opening that faces the engagement surface. The engagement surface and the receiving element define a second opening that faces in a direction substantially parallel to the engagement surface.

U.S. Pat. No. 2,653,499 to Arnold B. Partiss describes in combination with a flat faced vise jaw and a vertically extending support therefore, a vise jaw adapter comprising a rectangular shaped, flat plate member having upper, lower and opposite end marginal flanges extending rearwardly at substantially right angles thereto to form a dished portion, the upper marginal flange of said rectangular shaped plate member engaging the top of the vise jaw to position and support said plate member adjacent said jaw, the face of the vise jaw nesting in the dished portion, parallel lugs extending rearwardly from dished portion, said lugs being spaced from the opposite end flanges, and being positioned adjacent the lower flange and means for securing said spaced lugs to the portion of said vertically extending support for said jaw immediately below the face thereof, the support for said vise jaw having a transversely extending aperture therein and said lugs on said plate member having apertures therein for registration with transverse aperture in said support and a pin extending through said apertures in said support and said lugs, respectively, to secure the lower portion of said plate member adjacent the face of said vise jaw.

Notwithstanding the prior art, the present invention is neither taught nor rendered obvious thereby.

### SUMMARY OF INVENTION

A present invention multiple size fitting clamp pad pod that functions both as a clamp pad and as a support pod, includes: a main wall, being a vertical wall with a front, a back, a top, sides and a bottom, the main wall having a frontal view footprint that includes a central orifice adapted to fit onto and receive a first clamp bar (circular, rectangular or otherwise shaped in cross section) and that includes at least two opposing rest points located on the bottom, the central orifice having a first predetermined shape and open area to fit freely onto and receive the first clamp bar, and a break-away impression surrounding the central orifice to establish a second predetermined shape and open area to fit freely onto and receive a second clamp bar larger than the first clamp bar when the break-away impression is breached; and, a plurality of sidewalls located on the main wall and positioned and directed away from the main wall front.

In some preferred embodiments of the multiple size fitting clamp pad pod that functions both as a clamp pad and as a support pod, the pod includes a plurality of braces connected to the sidewalls and connected to the back of the main wall.

In some preferred embodiments of the multiple size fitting clamp pad pod that functions both as a clamp pad and as a support pod, the back of the main wall includes a jaw guide adapted to fit about at least a portion of a clamp jaw top and sides.

In some preferred embodiments of the multiple size fitting clamp pad pod that functions both as a clamp pad and as a support pod, the central orifice and the break-away impression are circular

In some preferred embodiments of the multiple size fitting clamp pad pod that functions both as a clamp pad and as a support pod, the central orifice and the break-away impression are rectangular.

In some preferred embodiments of the multiple size fitting clamp pad pod that functions both as a clamp pad and as a support pod, the break-away impression is selected from the group consisting of at least one thin element, perforations, a closed-loop recess, an open-loop recess and combinations thereof.

In some preferred embodiments of the multiple size fitting clamp pad pod that functions both as a clamp pad and as a support pod, the break-away impression includes at least one cut-out extending from the orifice inwardly.

In some preferred embodiments of the multiple size fitting clamp pad pod that functions both as a clamp pad and as a support pod, the frontal view footprint includes three sides of shape selected from the group consisting of a triangle, a rectangle and a trapezoid.

In some preferred embodiments of the multiple size fitting clamp pad pod that functions both as a clamp pad and as a support pod, the at least two opposing rest points located in aid bottom are flat segments with an arcuate opening therebetween.

In some preferred embodiments of the multiple size fitting clamp pad pod that functions both as a clamp pad and as a support pod, the at least two opposing rest points are at opposite ends of a single plane flat surface.

In another embodiment of the present invention, there is, in combination, a clamp assembly and a pair of opposing multiple size fitting clamp pad pods, which comprises: a) a clamp assembly, including a clamp shaft selected from the group consisting of a pipe and a bar, a set of two adjustable-position, locking opposing clamp jaws moveably and lockably located on the clamp shaft, and a drive mechanism connected to one of the clamp jaws and the clamp shaft for advancing and clamping the one of the clamp jaws, the drive mechanism being selected from the group consisting of (ii) a rotating drive mechanism having a predetermined clearance length equal to the maximum distance between a center of rotation and the furthest aspect of the rotating drive mechanism from the center of rotation, and (ii) a handle and trigger drive mechanism having a predetermined clearance length equal to the maximum distance between the center of the clamp shaft and furthest aspect of the handle from the center of the clamp shaft; b) wherein, for each pod, there comprises: a main wall, being a vertical wall with a front, a back, a top, sides and a bottom, the main wall having a frontal view footprint that includes a central orifice adapted to fit onto and receive a first clamp bar and that includes at least two opposing rest points located on the bottom, the central orifice having a first predetermined shape and open area to fit freely onto and receive the first clamp bar, and a break-away impression surrounding the central orifice to establish a second predetermined shape and open area to fit freely onto and receive a second clamp bar larger than the first clamp bar when the break-away impression is breached; and a plurality of sidewalls located on the main wall and positioned and directed away from the main wall front.

In some preferred embodiments of the present invention clamp assembly and pair of opposing multiple size fitting clamp pad pods, each pod includes a plurality of braces connected to the sidewalls and connected to the back of the main wall.

In some preferred embodiments of the present invention clamp assembly and pair of opposing multiple size fitting clamp pad pods, for each pod, the back of the main wall includes a jaw guide adapted to fit about at least a portion of a clamp jaw top and sides.

In some preferred embodiments of the present invention clamp assembly and pair of opposing multiple size fitting clamp pad pods, for each pod, the central orifice and the break-away impression are circular.

In some preferred embodiments of the present invention clamp assembly and pair of opposing multiple size fitting clamp pad pods, for each pod, the central orifice and the break-away impression are rectangular.

In some preferred embodiments of the present invention clamp assembly and pair of opposing multiple size fitting clamp pad pods, for each pod, the break-away impression being selected from the group consisting of at least one thin element, perforations, a closed-loop recess, an open-loop recess and combinations thereof.

In some preferred embodiments of the present invention clamp assembly and pair of opposing multiple size fitting clamp pad pods, for each pod, the break-away impression includes at least one cut-out extending from the orifice inwardly.

In some preferred embodiments of the present invention clamp assembly and pair of opposing multiple size fitting clamp pad pods, for each pod, the frontal view footprint includes three sides of shape selected from the group consisting of a triangle, a rectangle and a trapezoid.

In some preferred embodiments of the present invention clamp assembly and pair of opposing multiple size fitting clamp pad pods, for each pod, the at least two opposing rest points located in aid bottom are flat segments with an arcuate opening therebetween.

In some preferred embodiments of the present invention clamp assembly and pair of opposing multiple size fitting clamp pad pods, for each pod, the at least two opposing rest points are at opposite ends of a single plane flat surface.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a front perspective view of a multiple size fitting clamp pad pod with perforations for a break-away impression.

FIG. 2 is a back perspective view of the multiple size fitting clamp pad pod of FIG. 1;

FIG. 3 is a side perspective view clamp assembly and a pair of opposing multiple fitting clamp pad pods;

FIG. 4 is a front view of another embodiment of a multiple size fitting clamp pad pod;

FIG. 5 is a side cutaway view of the multiple size fitting clamp pod of FIG. 4;

FIG. 6 is a back view of another embodiment of a multiple size fitting clamp pad pod with perforations for a break-away impression;

FIG. 7 is a front view of another embodiment of a multiple size fitting clamp pad pod with a frontal view footprint being approximately rectangular; and

FIG. 8 is a front view of another embodiment of a multiple size fitting clamp pad pod with a sides and bottom having cut-outs, as well as perforations for a break-away impression.

### DETAILED DESCRIPTION OF THE EMBODIMENTS

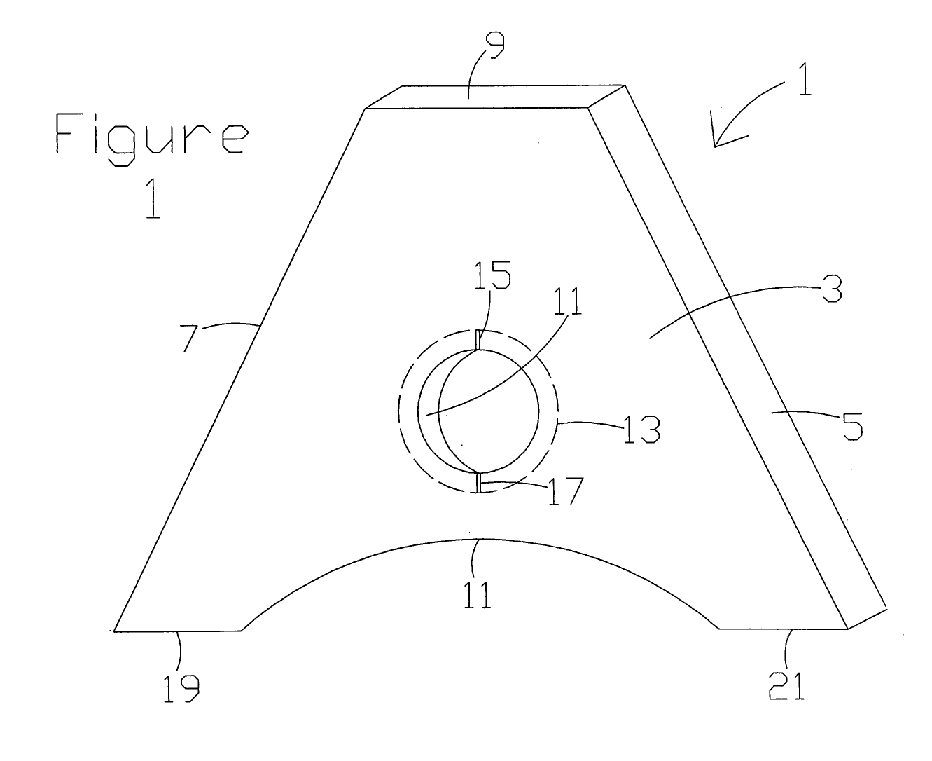

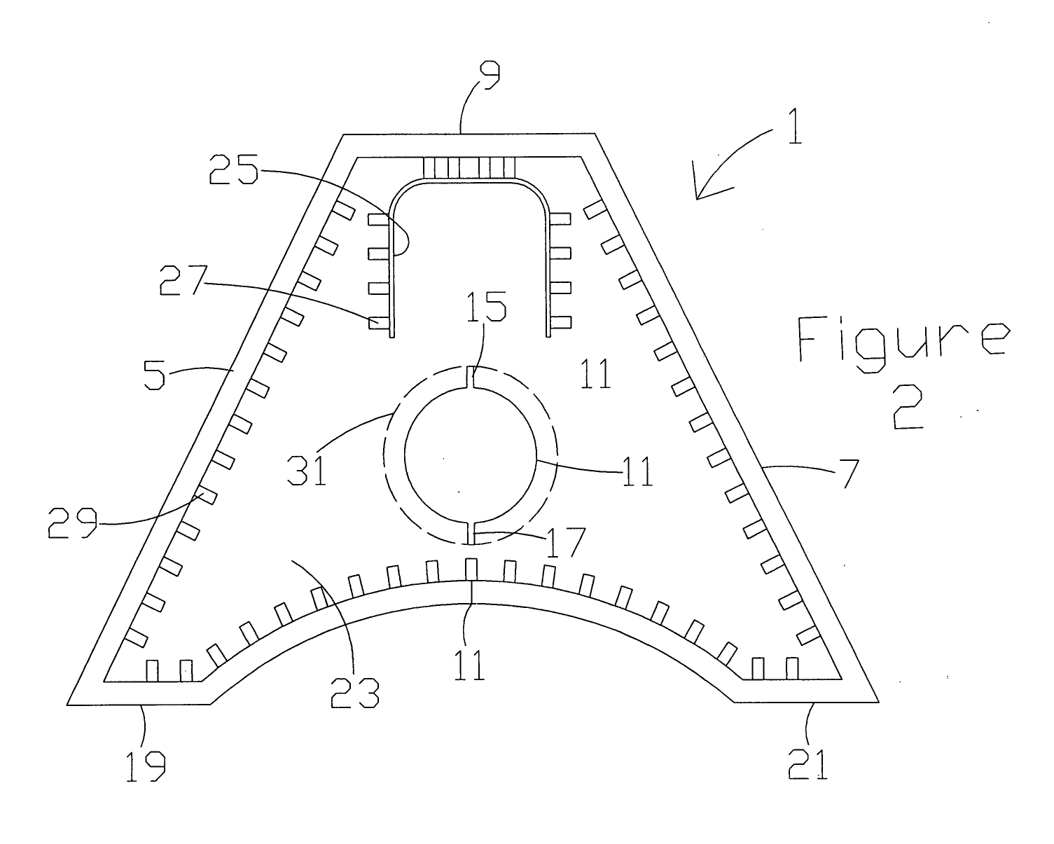

Referring now to the drawings wherein like reference numerals designate corresponding parts throughout the several views, FIG. 1 is a front perspective view of a present invention multiple size fitting clamp pad pod while FIG. 2 is a back perspective view thereof.

The multiple size fitting clamp pad pods of the following figures have been invented for the purpose of being produced using injection molding without the use of compound movement or cam action. By eliminating the need for compound movement or cam action in the injection molding of the present invention, the production complexity is greatly reduced.

The present invention multiple size fitting clamp pad pod 1 that functions both as a clamp pad and as a support pod, includes a main wall, being a vertical wall with a front 3, a back 23, a top 9, sides 5, 7 and a bottom 11. The main wall has a frontal view footprint that includes a central orifice 11 adapted to fit onto and receive a first clamp bar and that includes at least two opposing rest points 19, 21 located on the bottom.

The front 3 view footprint includes three sides of shape selected from the group consisting of a triangle, a rectangle and a trapezoid. In this case, the front 3 view footprint is generally trapezoidal. As shown, the at least two opposing rest points 19, 21 are flat segments with an arcuate opening therebetween

The central orifice 11 has a first predetermined shape and open area to fit freely onto and receive the first clamp bar, and a break-away impression 13 and cut-outs 15 and 17 surrounding the central orifice 11 to establish a second predetermined shape and open area to fit freely onto and receive a second clamp bar larger than the first clamp bar when the break-away impressions 13 and cut-outs 15 and 17 are breached.

The multiple size fitting clamp pad pod 1 further includes a plurality of braces 29 connected to the sides 5, 7, top 9, bottom 11 and opposing resting points 19, 21 and connected to the back 23.

The back 23 includes a jaw guide 25 adapted to fit about at least a portion of a clamp jaw top and sides.

As shown in FIGS. 1 and 2, the central orifice 11 and the break-away impression 13 are circular. The break-away impression 13 includes cut-outs 15 and 17 extending from the orifice inwardly for breaking away the section from the circular orifice 11. The central orifice 11 and the break-away impression 13 may also be rectangular. The break-away impression 13 may be selected from the group consisting of at least one thin element, perforations, a closed-loop recess, an open-loop recess and combinations thereof.

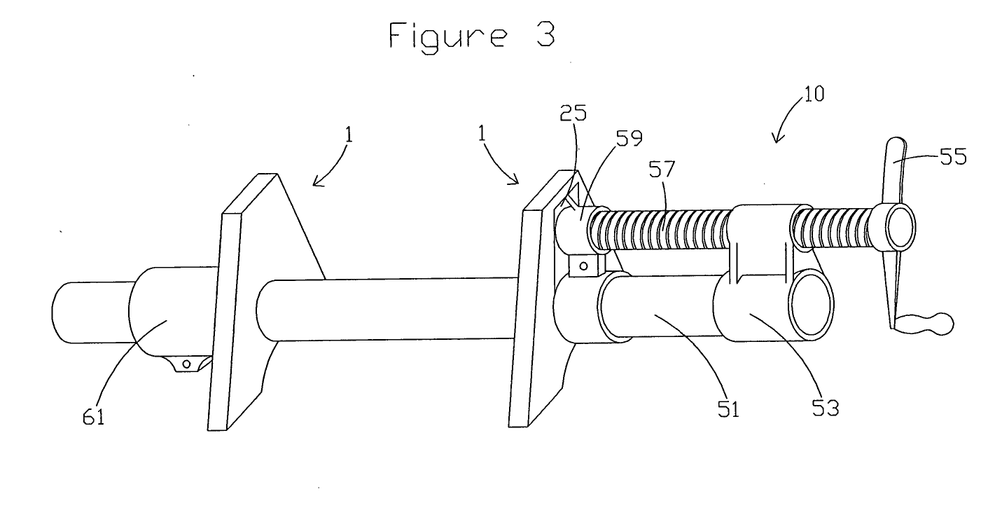

FIG. 3 is a side perspective view clamp assembly with a pair of opposing multiple fitting clamp pad pods 1 attached thereon. Opposing multiple fitting clamp pad pods 1 are fit onto bar clamp 10 by jaw guide 25. In use, left jaw 61 is fixed along bar 51, and right jaw 59 is moveably attached to bar 51. By turning handle 55 clockwise, threaded shaft 57 moves through the threaded bar end collar 53 and moves right jaw 59 toward left jaw 61. Similarly, turning handle 55 counterclockwise moves opposing multiple fitting clamp pad pods 1 away from each other.

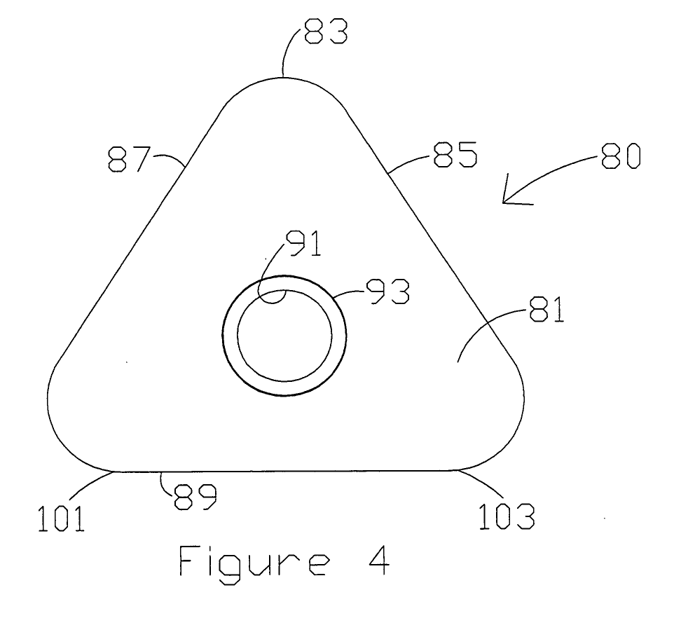

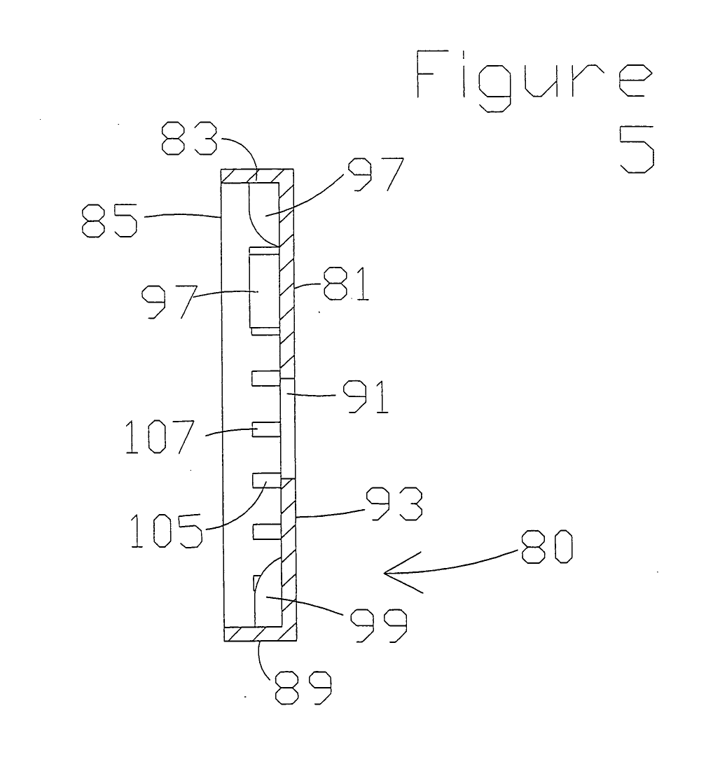

FIG. 4 is a front view of another embodiment of a multiple size fitting clamp pad pod 80 with a front 81 view footprint being generally triangular, as well as a break-away impression 93 while FIG. 5 is a partial cross sectional side view thereof.

The present invention multiple size fitting clamp pad pod 80 that functions both as a clamp pad and as a support pod, includes a main wall 81, a top 83, sides 85, 87 and a bottom 89. The main wall 81 includes a central orifice 91 adapted to fit onto and receive a first clamp bar and includes at least two opposing rest points 101, 103 located on the bottom 89.

The front 81 view footprint is triangular. As shown, the at least two opposing rest points 101, 103 located on the bottom 89 are flat segments.

The central orifice 91 has a first predetermined shape and open area to fit freely onto and receive the first clamp bar, and a break-away impression 93 surrounding the central orifice 91 to establish a second predetermined shape and open area to fit freely onto and receive a second clamp bar larger than the first clamp bar when the break-away impression 93 is breached.

The multiple size fitting clamp pad pod 81 further includes a plurality of braces 105, 107 connected to the sidewalls 83, 85, 87, 89 and connected to the main wall 81. The main wall 81 includes a jaw guide 97 adapted to fit about at least a portion of a clamp jaw top and sides.

As shown in FIGS. 4 and 5, the central orifice 91 and the break-away impression 93 are circular. The break-away impression 93 includes a closed-loop recess. The central orifice 91 and the break-away impression 93 may also be rectangular. The break-away impression 93 may be selected from the group consisting of at least one thin element, perforations, a closed-loop recess, an open-loop recess and combinations thereof.

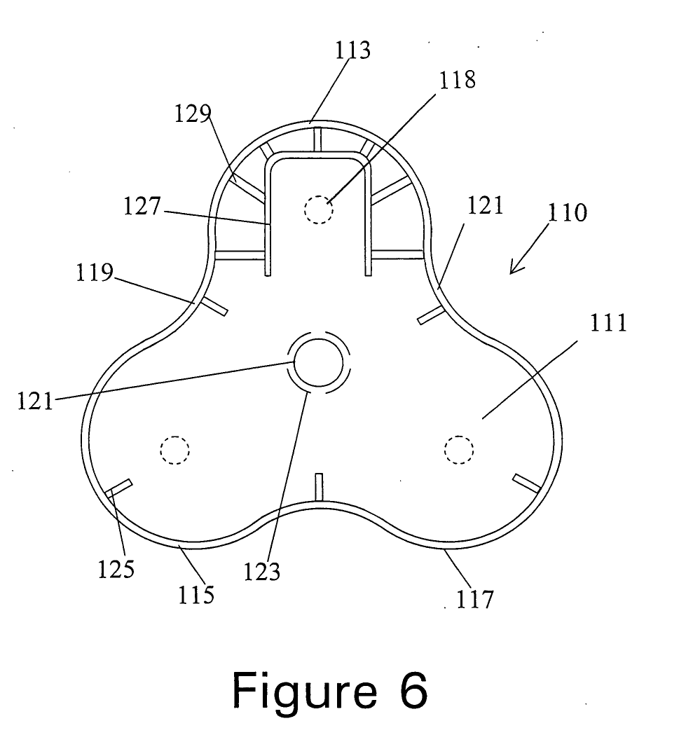

FIG. 6 is a back view of another embodiment of a multiple size fitting clamp pad pod 110 with a back view footprint being symmetrical, as well as an open-loop recess for a break-away impression. The multiple size fitting clamp pad pod 110 functions both as a clamp pad and as a support pod, includes a main wall 111, a top 113 and sides 119, 121. The main wall 111 has a back view footprint that includes a central orifice 121 adapted to fit onto and receive a first clamp bar and that includes at least two opposing rest points 115, 117 located on the bottom of main wall 111.

The back view footprint of main wall 111 as shown is approximately triangular, however other shapes may be selected as described above. As shown, the at least two opposing rest points 115, 117 are flat segments on main wall 111.

The central orifice 121 has a first predetermined shape and open area to fit freely onto and receive the first clamp bar, and a break-away impression 123 surrounding the central orifice 121 to establish a second predetermined shape and open area to fit freely onto and receive a second clamp bar larger than the first clamp bar when the break-away impression 123 is breached.

The multiple size fitting clamp pad pod 110 further includes a plurality of braces 101, 125, 129 connected to the top 113, sides 117 and 119 and the back of the main wall 111. The back of the main wall 11 includes a jaw guide 127 adapted to fit about at least a portion of a clamp jaw top and sides. All braces, such as 129, near jaw guide 127 connects jaw guide 127 to the side, side 119 for brace 129, for added strength. Main wall 111 is fitted with magnets 118 to provide improved grip to multiple size fitting clamp pad pod 110. As shown, magnets 118 are located about central orifice 121 in a radial symmetrical pattern, although other placements and quantities of magnets may be used.

As shown in FIG. 6, the central orifice 121 and the break-away impression 123 are circular. The break-away impression 123 includes an open loop recess. The central orifice 121 and the break-away impression 123 may also be rectangular. The break-away impression 123 may be selected from the group consisting of at least one thin element, perforations, a closed-loop recess, an open-loop recess and combinations thereof.

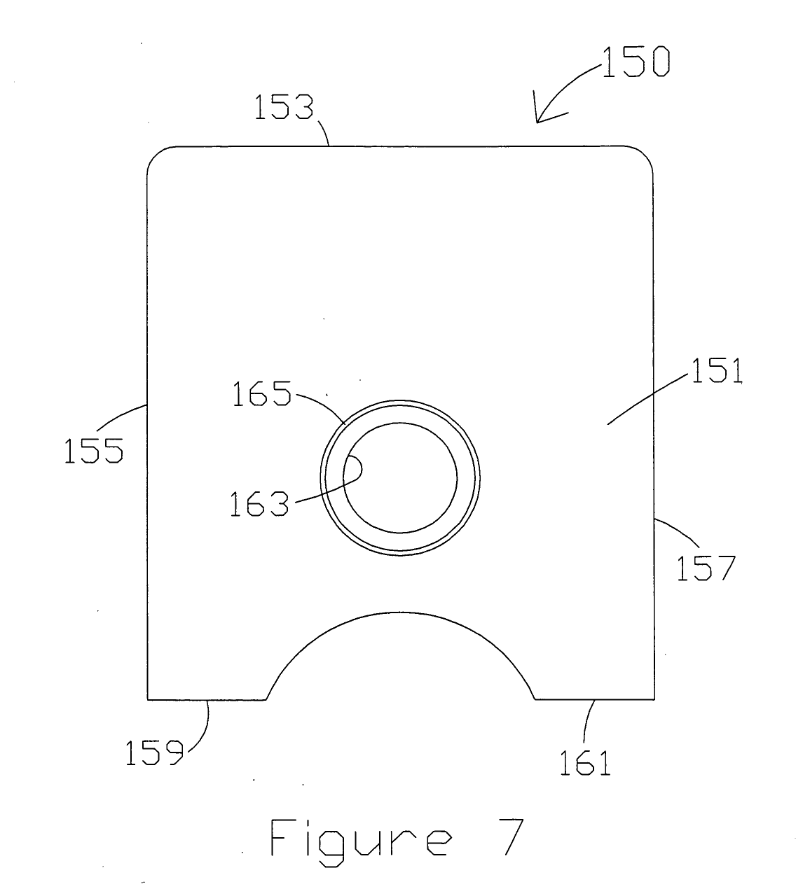

FIG. 7 is a front view of another embodiment of a multiple size fitting clamp pad pod 150 with a main wall 151 being approximately rectangular. The multiple size fitting clamp pad pod 150 functions both as a clamp pad and as a support pod, includes a main wall 151, a top 153, and sides 155, 157. The main wall 151 has a frontal view footprint that includes a central orifice 163 adapted to fit onto and receive a first clamp bar and that includes at least two opposing rest points 159, 161 located on the main wall 151. In the current embodiment, the main wall 151 is rectangular and the two opposing rest points 159, 161 are flat segments with an arcuate opening therebetween.

The central orifice 163 has a first predetermined shape and open area to fit freely onto and receive the first clamp bar, and a break-away impression 165 surrounding the central orifice to establish a second predetermined shape and open area to fit freely onto and receive a second clamp bar larger than the first clamp bar when the break-away impression 165 is breached.

As shown in FIG. 7, the central orifice 163 is circular and the break-away impression 165 is circular. The break-away impression 165 includes a closed-loop recess. The break-away impression 165 may be selected from the group consisting of at least one thin element, perforations, a closed-loop recess, an open-loop recess and combinations thereof.

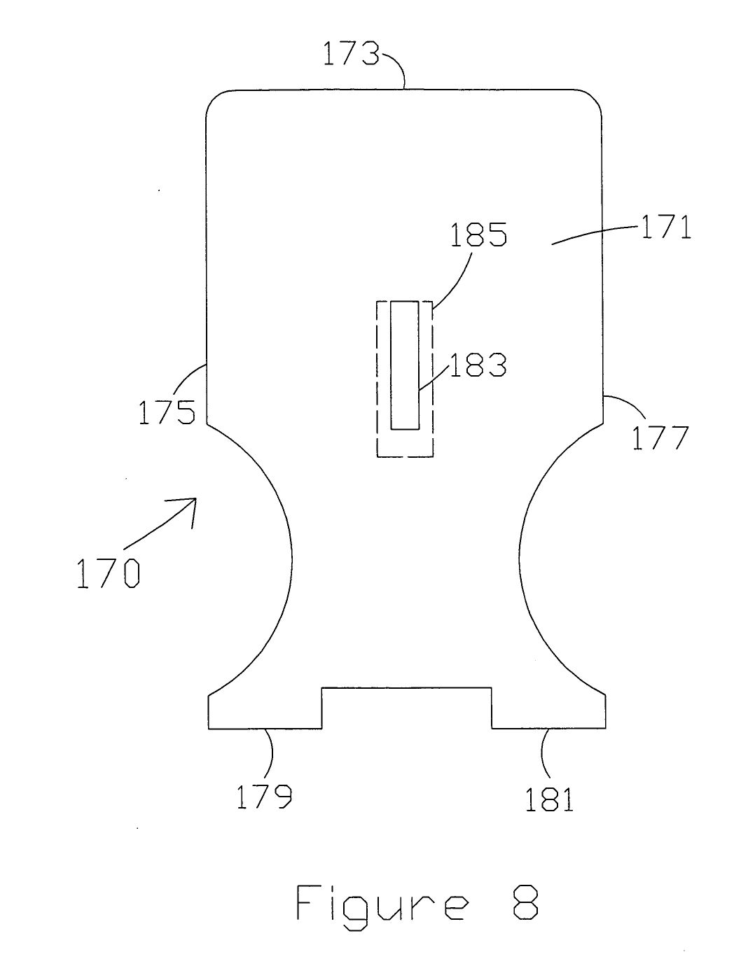

FIG. 8 is a front view of another embodiment of a present multiple size fitting clamp pad pod 170 with a sides and bottom having cut-outs, as well as perforations for a break-away impression.

The present invention multiple size fitting clamp pad pod 170 functions both as a clamp pad and as a support pod, and includes a main wall 171, a top 173 and sides 175, 177. The main wall 171 has a frontal view footprint that includes a central orifice 183 adapted to fit onto and receive a first clamp bar and that includes at least two opposing rest points 179, 181 located on the main wall 171.

The frontal view footprint includes three sides of shape selected from the group consisting of a triangle, a rectangle and a trapezoid. In this case, the main wall is rectangular. As shown, the two opposing rest points 179, 181 are located on the bottom of main wall 171 and are flat segments with an arcuate opening therebetween.

The central orifice 183 has a first predetermined shape and open area to fit freely onto and receive the first clamp bar, and a break-away impression 185 surrounding the central orifice 183 to establish a second predetermined shape and open area to fit freely onto and receive a second clamp bar larger than the first clamp bar when the break-away impression 185 is breached.

As shown in FIG. 8, the central orifice 183 and the break-away impression 185 are rectangular. The break-away impression 185 includes a closed-loop recess. The break-away impression 185 may be selected from the group consisting of at least one thin element, perforations, a closed-loop recess, an open-loop recess and combinations thereof.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A multiple size fitting clamp pad pod that functions both as a clamp pad and as a support pod, which comprises:
a main wall, being a vertical wall with a front, a back, a top, sides and a bottom, said main wall having a frontal view footprint that includes a central orifice adapted to fit onto and receive a first clamp bar and that includes at least two opposing rest points located on said bottom,
said central orifice having a first predetermined shape and open area to fit freely onto and receive said first clamp bar, and a break-away impression surrounding said central orifice to establish a second predetermined shape and open area to fit freely onto and receive a second clamp bar larger, than said first clamp bar when said break-away impression is breached; and
a plurality of sidewalls located on said main wall and positioned and directed away from said main wall front.

2. The multiple size fitting clamp pad pod that functions both as a clamp pad and as a support pod of claim 1, wherein said pod includes a plurality of braces connected to said sidewalls and connected to said back of said main wall.

3. The multiple size fitting clamp pad pod that functions both as a clamp pad and as a support pod of claim 1, wherein said back of said main wall includes a jaw guide adapted to fit about at least a portion of a clamp jaw top and sides.

4. The multiple size fitting clamp pad pod that functions both as a clamp pad and as a support pod of claim 1, wherein said central orifice and said break-away impression are circular.

5. The multiple size fitting clamp pad pod that functions both as a clamp pad and as a support pod of claim 1, wherein said central orifice and said break-away impression are rectangular.

6. The multiple size fitting clamp pad pod that functions both as a clamp pad and as a support pod of claim 1, wherein said break-away impression is selected from the group consisting of at least one thin element, perforations, a closed-loop recess, an open-loop recess and combinations thereof;

7. The multiple size fitting clamp pad pod that functions both as a clamp pad and as a support pod of claim 1, wherein said break-away impression includes at least one cut-out extending from said orifice inwardly.

8. The multiple size fitting clamp pad pod that functions both as a clamp pad and as a support pod of claim 1, wherein said frontal view footprint includes three sides of shape selected from the group consisting of a triangle, a rectangle and a trapezoid.

9. The multiple size fitting clamp pad pod that functions both as a clamp pad and as a support pod of claim 1, wherein said at least two opposing rest points located in aid bottom are flat segments with an arcuate opening therebetween.

10. The multiple size fitting clamp pad pod that functions both as a clamp pad and as a support pod of claim 1, wherein said at least two opposing rest points are at opposite ends of a single plane flat surface.

11. In combination, a clamp assembly and a pair of opposing multiple size fitting clamp pad pods, which comprises:
a) a clamp assembly, including a clamp shaft selected from the group consisting of a pipe and a bar, a set of two adjustable-position, locking opposing clamp jaws moveably and lockably located on said clamp shaft, and a drive mechanism connected to one of said clamp jaws and said clamp shaft for advancing and clamping said one of said clamp jaws, said drive mechanism being selected from the group consisting of (ii) a rotating drive mechanism having a predetermined clearance length equal to the maximum distance between a center of rotation and the furthest aspect of said rotating drive mechanism from said center of rotation, and (ii) a handle and trigger drive mechanism having a predetermined clearance length equal to the maximum distance between the center of the clamp shaft and furthest aspect of said handle from said center of the clamp shaft;
b) wherein, for each pod, there comprises: a main wall, being a vertical wall with a front, a back, a top, sides and a bottom, said main wall having a frontal view footprint that includes a central orifice adapted to fit onto and receive a first clamp bar and that includes at least two opposing rest points located on said bottom,
said central orifice having a first predetermined shape and open area to fit freely onto and receive said first clamp bar, and a break-away impression surrounding said central orifice to establish a second predetermined shape and open area to fit freely onto and receive a second clamp bar larger than said first clamp bar when said break-away impression is breached; and
a plurality of sidewalls located on said main wall and positioned and directed away from said main wall front.

12. The clamp assembly and pair of opposing multiple size fitting clamp pad pods of claim 11 wherein each pod includes a plurality of braces connected to said sidewalls and connected to said back of said main wall.

13. The clamp assembly and pair of opposing multiple size fitting clamp pad pods of claim 11 wherein, for each pod, said back of said main wall includes a jaw guide adapted to fit about at least a portion of a clamp jaw top and sides.

14. The clamp assembly and pair of opposing multiple size fitting clamp pad pods of claim 11 wherein, for each pod, said central orifice and said break-away impression are circular.

15. The clamp assembly and pair of opposing multiple size fitting clamp pad pods of claim 11 wherein, for each pod, said central orifice and said break-away impression are rectangular.

16. The clamp assembly and pair of opposing multiple size fitting clamp pad pods of claim 11 wherein, for each pod, said break-away impression is selected from the group consisting of at least one thin element, perforations, a closed-loop recess, an open-loop recess and combinations thereof.

17. The clamp assembly and pair of opposing multiple size fitting clamp pad pods of claim 11 wherein, for each pod, said break-away impression includes at least one cut-out extending from said orifice inwardly.

18. The clamp assembly and pair of opposing multiple size fitting clamp pad pods of claim 11 wherein, for each pod, said frontal view footprint includes three sides of shape selected from the group consisting of a triangle, a rectangle and a trapezoid.

19. The clamp assembly and pair of opposing multiple size fitting clamp pad pods of claim 11 wherein, for each pod, said at least two opposing rest points located in aid bottom are flat segments with an arcuate opening therebetween.

20. The clamp assembly and pair of opposing multiple size fitting clamp pad pods of claim 11 wherein, for each pod, said at least two opposing rest points are at opposite ends of a single plane flat surface.
